(19) United States
(12) Patent Application Publication
(10) Pub. No.: US 2015/0134531 A1
(43) Pub. Date: May 14, 2015

(54) METHOD, APPARATUS, AND SYSTEM FOR INFORMATION TRANSMISSION

(71) Applicant: TENCENT TECHNOLOGY (SHENZHEN) COMPANY LIMITED, Shenzhen (CN)

(72) Inventor: DONGMING XIA, Shenzhen (CN)

(73) Assignee: TENCENT TECHNOLOGY (SHENZHEN) COMPANY LIMITED

(21) Appl. No.: 14/596,547

(22) Filed: Jan. 14, 2015

Related U.S. Application Data
(63) Continuation of application No. PCT/CN2014/079079, filed on Jun. 3, 2014.

(30) Foreign Application Priority Data
Oct. 30, 2013 (CN) 2013-10530226.8

(51) Int. Cl. G06Q 20/40; G06Q 20/32

(52) U.S. Cl. CPC G06Q 20/40145; G06Q 20/40; G06Q 20/3278; G06Q 40/02
USPC 705/44

(57) ABSTRACT

Methods, apparatus, and systems for information transmission are disclosed herein. The receiving terminal generates an RF signal including payment information corresponding to a payment amount to be paid. The payment terminal receives the RF signal from the receiving terminal, parses the RF signal to obtain the payment information, and sends the payment request to the bank server according to the payment information. The payment request can includes the payment account number and the verification information of the payment account number. The bank server processes the payment request and sends a process result after processing to the payment terminal and the receiving terminal. Since the payment information is obtained through RF signal, compared with obtaining the payment information through internet in current technology, the present disclosure improves the security of the payment process, as well as the smartness of the information transmission systems.

### CROSS-REFERENCES TO RELATED APPLICATIONS

This application is a continuation application of PCT Patent Application No. PCT/CN2014/079079, filed on Jun. 3, 2014, which claims priority to Chinese Patent Application No. 201310530226.8, filed on Oct. 30, 2013, the entire content of both of which is incorporated herein by reference.

### FIELD OF THE DISCLOSURE

The present disclosure generally relates to the field of internet technology and, more particularly, relates to the field of payment technology including methods, apparatus, and systems for information transmission.

### BACKGROUND

With the development of internet technology, online payment is getting more and more popular. People can complete a payment or a payment transfer through internet frequently. Currently, online payment is conducted by first sending payment information through internet to a payment terminal by a receiving terminal or a transaction platform server, and then completing the payment through a bank server after the payment terminal obtains the payment information.

With the development of internet technology, hacking techniques are getting more and more advanced. Hackers may replace the payment information during the process of sending the payment information to the payment terminal through internet by the receiving terminal or the transaction platform server. Thus, the payment terminal may process the payment according to the hacked, replaced payment information. As such, the security of current payment technology is undesirably low.

### BRIEF SUMMARY OF THE DISCLOSURE

According to various embodiments, there is provided a method of information transmission. A payment terminal receives a RF signal generated and transmitted from a receiving terminal. The RF signal includes payment information corresponding to a payment amount to be paid. The payment terminal parses the RF signal to obtain the payment information. The payment terminal sends a payment request to a bank server, according to the payment information. The payment request includes a payment account number and verification information of the payment account number. The bank serer processes the payment request, and sends a process result after processing to the payment terminal and the receiving terminal.

According to various embodiments, there is provided a method of information transmission. An RF signal including payment information corresponding to a payment amount to be paid is generated. The RF signal is outputted to a payment terminal for the payment terminal to receive the RF signal and to parse the RF signal to obtain the payment information, and for the payment terminal to send a payment request to a bank server according to the payment information such that the bank server processes the payment request. A process result is received after the payment request is processed and sent from the bank server.

A non-transitory computer storage medium is configured to store a program and the program is executed according to the disclosed method of information transmission.

According to various embodiments, there is provided a method of information transmission. An RF signal including payment information outputted from a receiving terminal is received. The RF signal includes a wireless NFC signal, a RFID signal, a bluetooth signal, or an infrared signal. The RF signal is parsed to obtain the payment information. A payment request is sent to a banker server according to the payment information. The payment request includes a payment account number and verification information of the payment account number for the bank server to process the payment request. A process result is received after the payment request is processed and sent from the bank server.

According to various embodiments, there is provided an apparatus of information transmission. The apparatus includes a generating unit, an outputting unit, and a receiving unit. The generating unit configured to generate an RF signal including payment information corresponding to a payment amount to be paid. The outputting unit is configured to output the RF signal to a payment terminal for the payment terminal to receive the RF signal and to parse the RF signal to obtain the payment information, and for the payment terminal to send a payment request to a bank server according to the payment information such that the bank server processes the payment request. The receiving unit configured to receive a process result after the payment request is processed and sent from the bank server.

According to various embodiments, there is provided an apparatus of information transmission. The apparatus includes a signal receiving unit, a sending unit, and a result receiving unit. The signal receiving unit is configured to receive an RF signal including payment information outputted from a receiving terminal, and to parse the RF signal to obtain the payment information. The RF signal includes a wireless NFC signal, a RFID signal, a bluetooth signal, or an infrared signal. The sending unit is configured to send a payment request to a banker server according to the payment information. The payment request includes a payment account number and verification information of the payment account number for the bank server to process the payment request. The result receiving unit is configured to receive a process result after the payment request is processed and sent from the bank server.

According to various embodiments, there is provided a system of information transmission. The information transmission system includes a payment terminal. The payment terminal is configured to receive a RF signal generated and transmitted from a receiving terminal, the RF signal including payment information corresponding to a payment amount to be paid. The payment terminal is also configured to parse the RF signal to obtain the payment information, and to send a payment request to a bank server according to the payment information. The payment request includes a payment account number and verification information of the payment account number. The bank server is configured to process the payment request, and send a process result to the payment terminal and the receiving terminal.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary information transmission method consistent with various disclosed embodiments;

FIG. 2 depicts another exemplary information transmission method consistent with various disclosed embodiments;

FIG. 3 depicts another exemplary information transmission method consistent with various disclosed embodiments;

FIG. 4 depicts an exemplary illustration for information transmission consistent with various disclosed embodiments;

FIG. 5 depicts an exemplary information transmission apparatus consistent with various disclosed embodiments;

FIG. 6 depicts another exemplary information transmission apparatus consistent with various disclosed embodiments;

FIG. 7 depicts another exemplary information transmission apparatus consistent with various disclosed embodiments;

FIG. 8 depicts another exemplary information transmission apparatus consistent with various disclosed embodiments;

FIG. 9 depicts an exemplary information transmission system consistent with various disclosed embodiments; and

FIG. 10 depicts another exemplary information transmission system consistent with various disclosed embodiments.

### DETAILED DESCRIPTION

Reference can now be made in detail to exemplary embodiments of the disclosure, which are illustrated in the accompanying drawings. Wherever possible, the same reference numbers can be used throughout the drawings to refer to the same or like parts.

As used herein, a receiving terminal can be any terminals capable of outputting radio frequency (RF) signals and with communication functions. The receiving terminal can include, for example, tablet computers, mobile phones, e-readers, remote controls, personal computers (PCs), laptop computers, car-carried terminal devices, network televisions, wearable devices, and/or other smart devices. A payment terminal can be any terminals capable of receiving RF signals and with communication functions. The payment terminal can include, for example, tablet computers, mobile phones, e-readers, remote controls, personal computers (PCs), laptop computers, car-carried terminal devices, network televisions, wearable devices, and/or other smart devices.

The information transmission methods provided herein can be used in any payment related cases. For example, the information transmission method provided by the present disclosure can be used, when shopping in a market place or a shopping center. During checkout, the receiving terminal generates a radio frequency (RF) signal including payment information corresponding to a payment amount to be paid; the payment terminal obtains the payment information by receiving the RF signal transmitted from the receiving terminal, and sends a payment request to a bank server, according to the payment information; and the bank server processes the payment request, and sends a process result after processing to the payment terminal and the receiving terminal.

The information transmission methods can also be used in payment transfers between users. For example, during a payment transfer, the receiving terminal generates an RF signal including payment information corresponding to a payment amount to be paid; the payment terminal obtains the payment information by receiving the RF signal transmitted from the receiving terminal, and sends a payment request to a bank server, according to the payment information; and the bank server processes the payment request, and sends a process result after processing to the payment terminal and the receiving terminal.

The RF signal of the present disclosure may include a wireless near field communication (NFC) signal, a radio frequency identification (RFID) signal, a bluetooth signal, and/or an infrared signal. The payment request may include a payment account number and verification information of the payment account number. Since the payment information is obtained through RF signal, compared with obtaining the payment information through internet in current technology, the present disclosure improves the security of the payment process, as well as the smartness of the information transmission system.

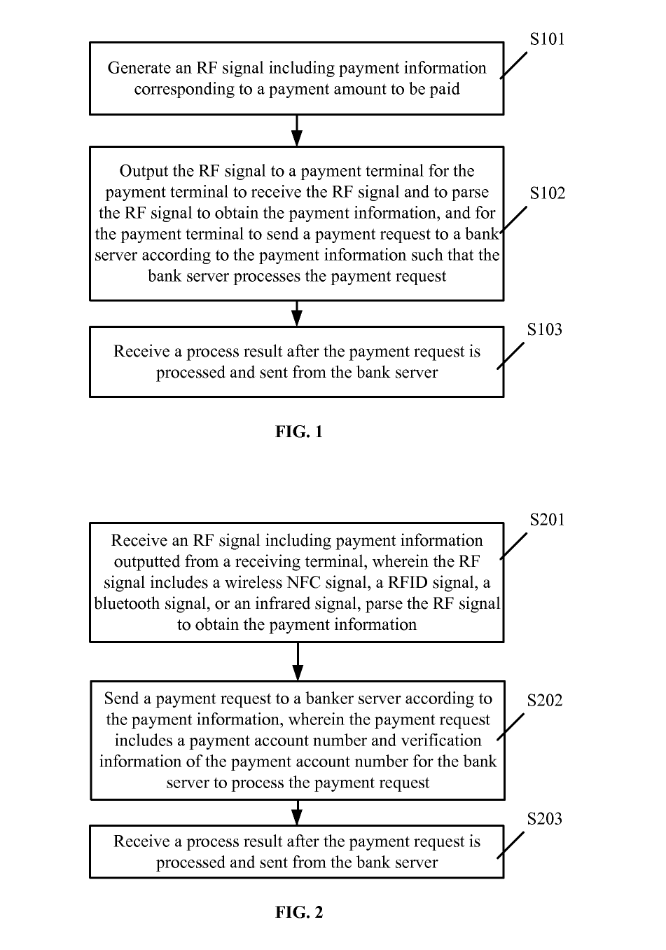

FIGS. 1-4 depict exemplary methods for information transmission consistent with various disclosed embodiments. As depicted in FIG. 1, the present disclosure provides an exemplary information transmission method, e.g., based on a side of a receiving terminal.

In Step S101, an RF signal including payment information corresponding to a payment amount to be paid is generated. Specifically, the receiving terminal can receive operation from a receiving user to generate the RF signal including the payment information corresponding to a payment amount of a merchandise to be paid, or to generate the RF signal including the payment information corresponding to a payment amount of a payment transfer to be paid.

For example, according to the merchandise selected by the payment user at the payment terminal, the receiving user at the receiving terminal can operates the receiving terminal to generate an RF signal including the payment information corresponding to a payment amount of the merchandise to be paid. Note that, the receiving terminal can scan the RF label from the merchandise to be paid, and generate an RF signal including the payment information corresponding to a payment amount of the merchandise according to the RF label. The payment information may be the payment information including the payment amount of the merchandise. Optionally, the receiving terminal can generate above RF signal(s) through a specific application program, so as to achieve speedy generation of the RF signal, and to improve the payment efficiency. The application program can be an RF signal generating program of an instant messaging communication application.

In Step S102, the RF signal is outputted to the payment terminal for the payment terminal to receive the RF signal and to parse the RF signal to obtain the payment information, and for the payment terminal to send a payment request to a bank server according to the payment information such that the bank server processes the payment request. Specifically, the receiving terminal generates and outputs an RF signal including the payment information through an application program. The payment terminal receives the RF signal to obtain the payment information.

The payment information can include the payment amount to be paid. Or the payment information can include the payment amount and receiving account number information. When the payment information does not include the receiving account number, the payment terminal can first obtain the information of the application program that displays the above RF signal, and then find the receiving account number through the application program. For example, the payment terminal can pre-obtain a corresponding relationship between information of the application program and the receiving account number. The payment terminal can then obtain the receiving account number according to the corresponding relationship. In some cases, the payment terminal does not need to obtain the receiving account number, e.g. the receiving account number can be found by the terminal ID of the receiving terminal, when the payment request is processed by the bank server.

The payment terminal sends the payment request to the bank server according to the payment information such that the bank server processes the payment request.

In Step S103, after processing the payment request, a process result sent from the bank server is received. Specifically, the process result can include a successful payment or a failed payment. When the payment amount of the payment account number is transferred to the receiving account number, the payment is successful, otherwise the payment is unsuccessful. Optionally, once the receiving terminal receives the process result after the payment request is processed, the receiving terminal may output the process result. As such, the receiving terminal generates RF signal including the payment information corresponding to a payment amount to be paid; the payment terminal obtains the payment information by receiving the RF signal transmitted from the receiving terminal. Since the payment information is obtained through RF signal, compared with obtaining the payment information through internet in current technology, the present disclosure improves the security of the payment process.

FIG. 2 depicts another exemplary information transmission method, e.g., based on a side of a payment terminal, consistent with various disclosed embodiments.

In Step S201, an RF signal including payment information outputted from a receiving terminal is received. The RF signal includes a wireless NFC signal, a RFID signal, a bluetooth signal, and/or an infrared signal. The RF signal is parsed to obtain the payment information. Specifically, the receiving terminal generates and outputs an RF signal including the payment information through an application program.

The payment terminal receives the RF signal. The payment information can include the payment amount to be paid. Or the payment information can include both the payment amount to be paid and the receiving account number information. When the payment information does not include the receiving account number, the payment terminal can first obtain the information of the application program that displays the above RF signal, and then find the receiving account number through the application program. For example, the payment terminal can pre-obtain a corresponding relationship between information of the application program and the receiving account number. The payment terminal can then obtain the receiving account number according to the corresponding relationship. In some cases the payment terminal does not need to obtain the receiving account number, e.g. the receiving account number can be found by the terminal ID of the receiving terminal, when the payment request is processed by the bank server.

In Step S202, a payment request is sent to a banker server according to the payment information. The payment request includes a payment account number and verification information of the payment account number for the bank server to process the payment request.

Specifically, when the payment terminal obtains the payment information, the payment terminal obtains the payment account number and the verification information of the payment account number. The payment terminal then sends a payment request including the payment account number and the verification information of the payment account number according to the payment information to a bank server. For example, the payment terminal sends the payment request including above payment information, the payment account number and the verification information of the payment account number to the bank server.

Optionally, the above payment account number and the verification information of the payment account number can be the payment account number pre-stored at the payment terminal and the verification information of the payment account number pre-stored at the payment terminal. Or the above payment account number and the verification information of the payment account number can be inputted payment account number and inputted verification information of the payment account number. Or the above payment account number and the verification information of the payment account number can be the payment account number pre-stored at the payment terminal and inputted verification information of the payment account number. The verification information of the above payment account number can be the verification information needed by the bank server when the payment account number is used during payment transfer. The verification information can include, but are not limited to, password, expiration date, and/or card ID. Optionally, when the payment terminal sends the payment request including the payment account number and the verification information of the payment account number to the bank server, the payment request including the payment account number and the verification information of the payment account number can be sent via a wired and/or the wireless network to the bank server.

Optionally, the payment terminal can send the payment request including the payment account number and the verification information of the payment account number to the bank server through a transaction server. For example, Step S202 can include: the payment terminal sends the payment request to the transaction server according to the payment information, and the transaction server can send the payment request to the bank server.

The transaction server can be a server providing a specific application software program running on the payment terminal. For example, when the payment terminal receives above RF signal through certain communication software program and the above payment account number corresponds to the communication account number of the communication software, the payment terminal can obtain the payment account number and the verification information of the payment account number through the communication software program. The payment terminal can then send the payment request including the payment account number and the verification information of the payment account number to the transaction server according to the payment information.

The transaction server can send the payment request to the bank server. In one embodiment, the payment request is forwarded from the transaction server to the bank server. Since the servers (e.g., transaction server and the bank server) are harder to be attacked compared with terminals, the disclosed methods can improve the security of the payment process. Further, when the bank server receives the payment request, the bank server processes the payment request.

In 5203, after processing the payment request, a process result sent from the bank server is received. Specifically, the process result can include a successful payment or a failed payment.

When the payment amount of the payment account number is transferred to the receiving account number, the payment is successful, otherwise the payment is unsuccessful. Optionally, once the payment terminal receives the process result after the payment request is processed, the receiving terminal may output the process result. As such, the receiving terminal generates the RF signal including the payment information corresponding to a payment amount to be paid. The payment terminal receives the RF signal from the receiving terminal, parses the RF signal to obtain the payment information. The payment terminal sends the payment request including the payment account number and the verification information of the payment account number to the bank server according to the payment information. Since the payment information is obtained through RF signal, compared with obtaining the payment information through internet in current technology, the present disclosure provides various methods to improve the security of the payment process.

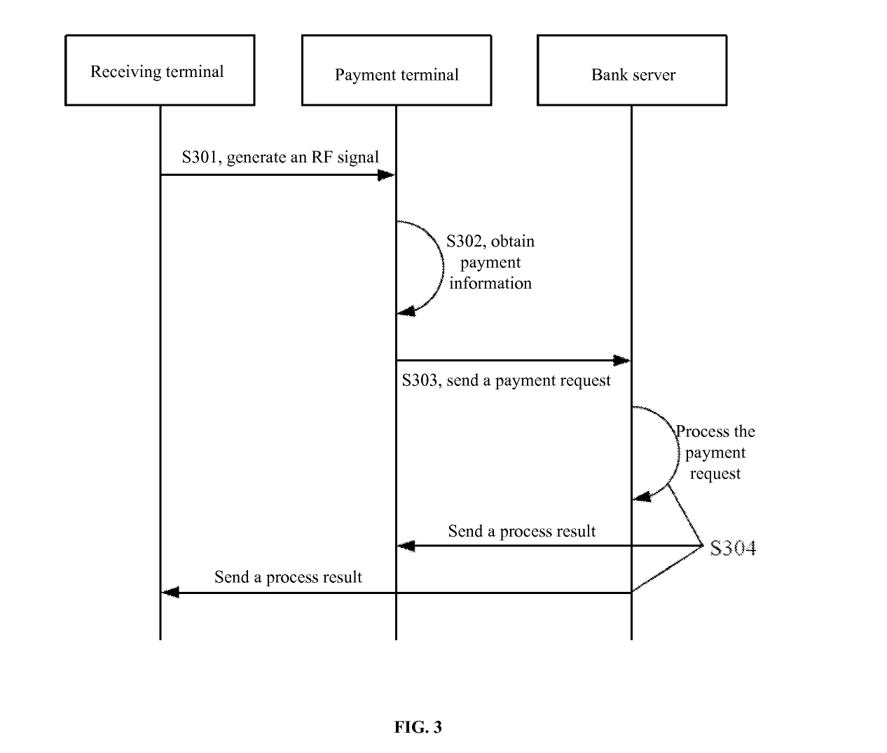

As depicted in FIG. 3, the present disclosure provides another exemplary information transmission method, e.g., based on the side of terminals including the receiving terminal and the payment terminal.

In Step S301, the receiving terminal generates an RF signal including payment information corresponding to a payment amount to be paid. Specifically, the receiving terminal can receive the operation from a receiving user to generate the RF signal including the payment information corresponding to a payment amount of a merchandise to be paid, or to generate the RF signal including the payment information corresponding to a payment amount of a payment transfer to be paid.

For example, according to the merchandise selected by the payment user at the payment terminal, the receiving user at the receiving terminal can operate the receiving terminal to generate an RF signal including the payment information corresponding to a payment amount of merchandise to be paid. Note that, the receiving terminal can scan the RF label from the merchandise to be paid, and generate the RF signal including the payment information corresponding to a payment amount of the merchandise according to the RF label. The payment information may be the payment information including the payment amount of the merchandise. Optionally, the receiving terminal can generate above RF signal(s) through a specific application program, to achieve speedy generation of the RF signal, and to improve the payment efficiency. In one embodiment, the application program can be an RF signal generating program of an instant messaging communication application.

In Step S302, the payment terminal receives the RF signal outputted from a receiving terminal. The RF signal includes a wireless NFC signal, a RFID signal, a bluetooth signal, and/or an infrared signal. The payment terminal parses the RF signal to obtain the payment information. Specifically, the receiving terminal generates and outputs an RF signal including the payment information through an application program. The payment terminal receives the RF signal.

The payment information can include the payment amount to be paid. Or the payment information can include both the payment amount to be paid and the receiving account number information. When the payment information does not include the receiving account number, the payment terminal can first obtain the information of the application program that displays the above RF signal, and then find the receiving account number through the application program. For example, the payment terminal can pre-obtain a corresponding relationship between information of the application program and the receiving account number. The payment terminal can then obtain the receiving account number according to the corresponding relationship. In some cases, the payment terminal does not need to obtain the receiving account number, e.g. the receiving account number can be found by the terminal ID of the receiving terminal when the payment request is processed by the bank server.

In Step S303, the payment terminal sends the payment request to the banker server according to the payment information. The payment request includes a payment account number and verification information of the payment account number.

Specifically, the payment terminal can send the payment request including above payment information, the payment account number, and the verification information of the payment account number to the bank server. The above payment information may include payment amount and the receiving account number. Or, the payment terminal can send the payment request including above payment information, the receiving account number, the payment account number, and the verification information of the payment account number to the bank server. The above payment information may include payment amount. The above receiving account number may be the pre-obtained receiving account number. For example, before the transfer between the payment terminal and the receiving terminal, the payment terminal obtains the receiving account number through the communication with the receiving terminal, or the payment terminal obtains the receiving account number by receiving the operation inputted from the user. Any suitable methods for obtaining the receiving account number can be used and encompassed herein without limitation.

Optionally, before performing Step S303, the payment terminal can obtain above payment account number and the verification information of the payment account number. For example, above payment account number and the verification information of the payment account number can be pre-stored at the payment terminal. For example, above payment account number and the verification information of the payment account number can be bound with the communication account number of the communication software program running on the payment terminal. Thus, when the payment terminal logs in with the communication account number, above payment account number and the verification information of the payment account number can be obtained through the communication account number. Of course, the binding can only be made between the payment account number and the communication account number without the verification information of the payment account. The verification information can be inputted when the payment amount is paid later.

For example, before implementing Step S303, the method can further include that the payment terminal obtains the pre-stored payment account number and the pre-stored verification information of the payment account number. The payment account number and the verification information of the payment account number can be obtained quickly in this manner to achieve speedy completion.

In another example, before implementing Step S303, the method can further include that the payment terminal obtains the pre-stored payment account number, and receives the inputted verification information of the payment account number. The payment account number can be obtained quickly in this manner. Since the verification information of the payment account number need to be inputted, for example, the payment terminal receives the verification information of the payment account number inputted by the payment user, the security of the payment process can be improved.

In another example, before implementing Step S303, the method can further include that the payment terminal receives the inputted payment account number and the inputted verification information of the payment account number. Since both the payment account number and the verification information of the payment account number needs to be inputted, e.g. the payment terminal receives payment account number and the verification information of the payment account number inputted by the payment user, the security of the payment process can be ensured.

In Step S304, the bank server processes the payment request and sends a process result after processing to the payment terminal and the receiving terminal.

Specifically, after the bank server receives the above payment request, the bank server can verify the verification information of the payment account number included in the payment request. For example, the verification information can be compared with the verification information of the payment account number bounded at the bank server. When the comparing result is consistent, the verification is successful and the payment request can be processed. For example, the payment amount can be transferred from the payment account number to the receiving account number. The receiving account number can come from the payment request, or the bank server can find the receiving account number according to the terminal ID of the payment terminal.

Optionally, that the bank server can send the process result after processing to the payment terminal and the receiving terminal by sending the process result to the payment terminal according to the terminal ID of the payment terminal, and to the receiving terminal according to the terminal ID of the receiving terminal. For example, above payment request may contain the terminal ID of the receiving terminal, or above payment request may contain the receiving account number, and the bank server can find the terminal ID of the receiving terminal through the receiving account number.

The process result can include a successful payment, e.g. the payment amount is transferred from the payment account number to the receiving account number. In addition, above process result can include a failed payment, e.g. the payment amount is not transferred from the payment account number to the receiving account number.

Optionally, after implementing Step S304, the method may further include that the receiving terminal outputs the process result. When the payment result indicates a successful payment, the receiving terminal can output information for the successful payment, e.g. displaying information of successful payment, or broadcasting an audio indicating the successful payment. When the receiving user obtains the successful payment, the merchandise corresponding to the payment should be delivered to the payment user. When the process result is the failed payment, the receiving terminal can output information for the failed payment, e.g. displaying information of failed payment, or broadcasting audio of failed payment. When the receiving user obtains the failed payment, the merchandise corresponding to the payment should not be delivered to the payment user. The payment user can be prompted to pay again, find another payment method, etc.

The payment terminal outputs the process result. When the payment result is successful, the payment terminal can output information for a successful payment, e.g. displaying information of successful payment, or broadcasting audio of successful payment. When the payment user obtains the successful payment, the merchandise corresponding to the payment should be obtained from the store of the receiving user. When the process result is failed payment, the payment terminal can output information for failed payment, e.g. displaying information of failed payment, or broadcasting audio of failed payment. When the payment user obtains the failed payment, the payment user can pay again, find another payment method, etc.

Optionally, when the payment amount included in above payment information is too high, e.g. when the payment amount exceeds a pre-set amount value, the payment terminal can conduct ID verification. For example, when the payment amount exceeds a pre-set amount value, the ID verification must be performed before the payment. For example, after Step S302 and before Step S303, the method can further include: when the payment amount included in the payment information exceeds a pre-set amount value, the payment terminal outputs a prompt message to prompt for ID verification. The payment terminal scans a body part for the ID verification to obtain ID verification information. The payment terminal verifies the ID verification information.

In various embodiments, exemplary Step S303 can include: after the ID verification information is successfully verified, the payment terminal sends a payment request to a bank server according to the payment information.

For example, after the payment terminal obtains above payment information, whether the payment amount included in the payment information exceeds a pre-set amount value can be determined. If the payment amount does not exceed the pre-set amount value, Step S303 can be processed. If the payment amount exceeds the pre-set amount value, the payment outputs a prompt message to prompt for ID verification. The payment terminal scans a body part for the ID verification to obtain ID verification information. The payment terminal verifies the ID verification information. For example, the payment terminal outputs an interface for scanning a fingerprint. The user inputs a fingerprint in the interface. The payment terminal scans the fingerprint to obtain the fingerprint information. The payment terminal compares the fingerprint information with the pre-stored fingerprint information of the payment user. When these two fingerprint information are consistent, the ID verification is passed and Step S303 can be processed. Thus, when the security of the payment process is improved, the speed of the payment process is ensued. In practical application, the payment amount of merchandise purchased by the payment user is usually low. There is no need to provide ID verification in certain situations. In some cases, the ID verification is conducted only when the payment amount is large.

Optionally, when the payment amount included in above payment information is too high, e.g. when the payment amount exceeds a pre-set amount value, the bank server can conduct ID verification, i.e. when the payment amount exceeds a pre-set amount value, the ID verification must be implemented before further process of the payment.

For example, after Step S302 and before Step S303 are performed, the method can further include: when the payment amount included in the payment information exceeds a pre-set amount value, the payment terminal outputs a prompt message to prompt for ID verification. The payment terminal scans a body part for the ID verification, to obtain ID verification information.

The exemplary Step S303 can include the payment terminal sends the payment request and the ID verification information to the bank server according to the payment information.

The exemplary Step S304 can include: the bank server verifies the ID verification information; and after the ID verification information is successfully verified, the bank server processes the payment request.

Specifically, before the bank server processes the payment request of the payment account number, the ID verification information inputted by the payment user of the registered payment account number can be received by the bank server. When the payment account number requests a large payment amount, only when the ID verification information sent by the payment terminal and the ID verification information inputted by the payment user of the registered payment account number pass the ID verification, the payment request can be processed, so as to improve the security when the payment account number requests a large payment amount.

Optionally, the scanning of the body part for the ID verification by the payment terminal to obtain the ID verification information includes: the payment terminal scans a fingerprint to obtain the fingerprint information. Specifically, fingerprint scanning can be conducted through a fingerprint sensor to obtain fingerprint information.

Optionally, the scanning of the body part for the ID verification by the payment terminal to obtain the ID verification information includes: the payment terminal scans a pupil to obtain the pupil information. Specifically, pupil scanning can be conducted through a camera to obtain fingerprint information.

Optionally, the scanning of the body part for the ID verification by the payment terminal to obtain the ID verification information includes: the payment terminal scans a face to obtain facial information. Specifically, face scanning can be conducted through a camera to obtain facial information. Of course, ID verification provided by the present disclosure includes, but is not limited to, the above listed ID verification information. As such, security of the payment process can be improved according to various disclosed embodiments.

As such, the receiving terminal generates the RF signal including the payment information corresponding to a payment amount to be paid. The payment terminal receives the RF signal from the receiving terminal and parses the RF signal to obtain the payment information. The payment terminal sends the payment request including the payment account number and the verification information of the payment account number to the bank server according to the payment information. Since the payment information is obtained through RF signal, compared with obtaining the payment information through internet in current technology, the security of the payment process can be improved, and the smartness of the information transmission system can be improved.

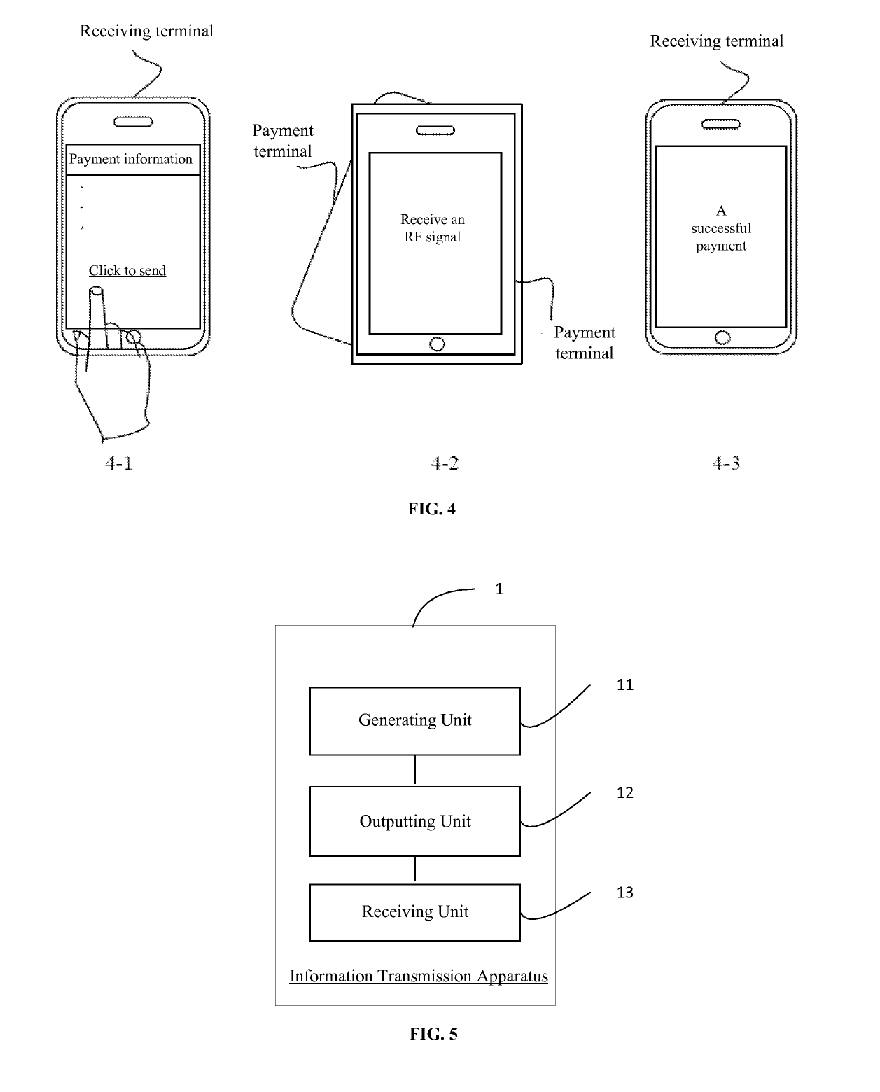

FIG. 4 depicts an example that a payment user may shop and select a target item at a store of a receiving user. The receiving user operates the receiving terminal to generate an RF signal including payment information corresponding to the selected item. As depicted in FIG. 4-1, the receiving user can output the RF signal by clicking on the screen of the receiving terminal. As depicted in FIG. 4-2, the payment user operates the payment terminal to receive the RF signal transmitted from the receiving terminal. The payment terminal obtains above payment information by parsing the RF signal, and sends a payment request to a bank server, according to the payment information. The bank server processes the payment request, and sends a process result to the payment terminal and the receiving terminal. When the receiving terminal receives the process result and the process result shows a successful payment, as depicted in FIG. 4-3, the receiving terminal displays a message of the successful payment. Once the receiving user knows the payment is successful, the above selected item can be delivered to the payment user to complete the transaction.

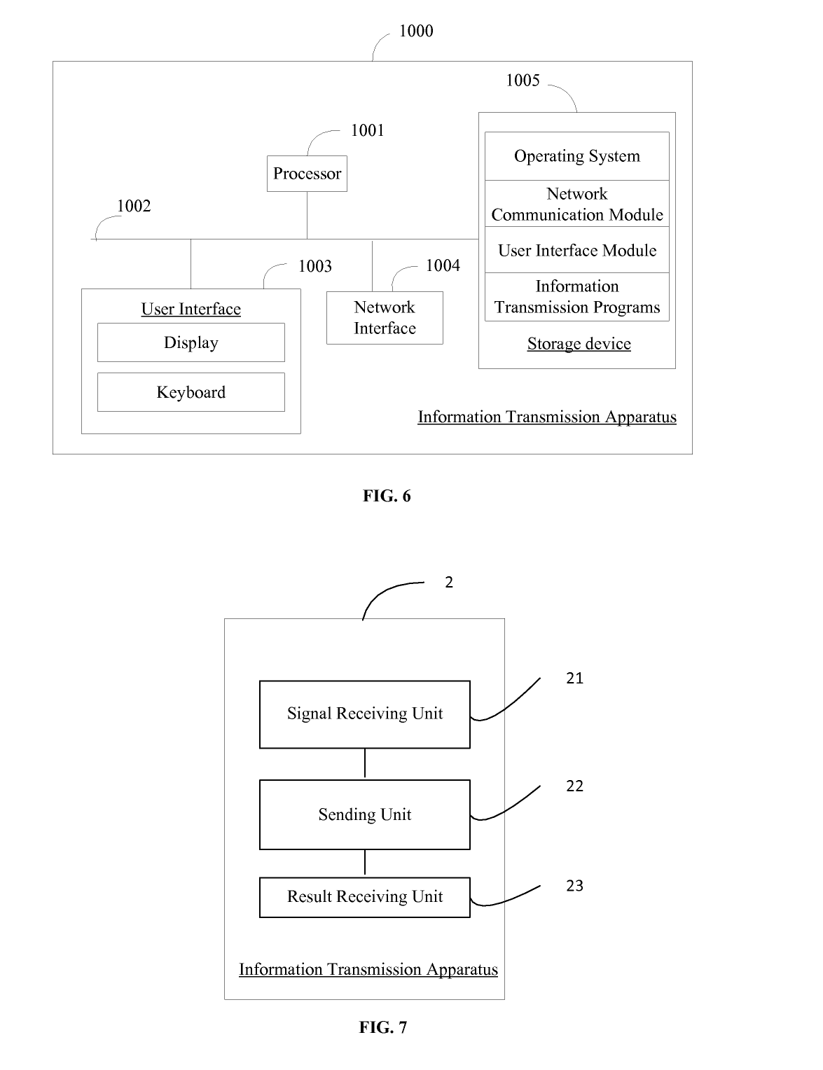

FIGS. 5-6 depict exemplary information transmission apparatuses consistent with various disclosed embodiments. It should be noted that apparatuses shown in FIGS. 5-6 can be, e.g., a receiving terminal, used to implement the disclosed information transmission methods, e.g., as depicted in FIG. 1. For illustration purposes, only certain portions are disclosed for the apparatuses, although the disclosed apparatuses can be used to implement all possible steps of the information transmission methods (e.g., referring to FIGS. 1-4).

As depicted in FIG. 5, the exemplary information transmission apparatus includes a generating unit 11, an outputting unit 12, and/or a receiving unit 13.

The generating unit 11 is configured to generate an RF signal including payment information corresponding to a payment amount to be paid. Specifically, the generating unit 11 can receive the operation from a receiving user to generate the RF signal including the payment information corresponding to a payment amount of a merchandise to be paid, or to generate the RF signal including the payment information corresponding to a payment amount of a payment transfer to be paid.

For example, according to the merchandise selected by the payment user at the payment terminal, the generating unit 11 generates an RF signal including the payment information corresponding to a payment amount of the merchandise to be paid. It should be noted that the generating unit 11 can scan the RF label from the merchandise to be paid, and generate the RF signal including the payment information corresponding to the payment amount of the merchandise according to the RF label. The payment information may be payment information including the payment amount of the merchandise. Optionally, the generating unit 11 can generate above RF signal through a specific application program, so as to achieve speedy generation of the RF signal, and to improve the payment efficiency. The application program can be a RF signal generating program of an instant messaging communication application.

The outputting unit 12 is configured to output the RF signal to the payment terminal for the payment terminal to receive the RF signal and to parse the RF signal to obtain the payment information, and for the payment terminal to send a payment request to a bank server according to the payment information such that the bank server processes the payment request. Specifically, the outputting unit 12 outputs an RF signal including the payment information through an application program. The payment terminal receives the RF signal to obtain the payment information.

The payment information can include the payment amount. Or the payment information can include the payment amount and the receiving account number information. When the payment information does not include the receiving account number, the payment terminal can first obtain the information of the application program that displays the above RF signal, and then find the receiving account number through the application program. For example, the payment terminal can pre-obtain a corresponding relationship between information of the application program and the receiving account number. The payment terminal can then obtain the receiving account number according to the corresponding relationship. In some cases, the payment terminal does not need to obtain the receiving account number, e.g. the receiving account number can be found by the terminal ID of the information transmission apparatus 1 when the payment request is processed by the bank server. The payment terminal sends the payment request to the bank server according to the payment information such that the bank server processes the payment request.

The receiving unit 13 is configured to receive a process result after the payment request is processed and sent from the bank server. Specifically, the process result can include a successful payment or a failed payment. When the payment amount of the payment account number is transferred to the receiving account number, the payment is successful, otherwise the payment is unsuccessful. Optionally, once the receiving unit 13 receives the process result after the payment request is processed, the receiving unit 13 may output the process result.

As such, the receiving terminal generates RF signal including the payment information corresponding to a payment amount to be paid. The payment terminal obtains the payment information by receiving the RF signal transmitted from the receiving terminal. Since the payment information is obtained through RF signal, compared with obtaining the payment information through internet in current technology, the security of the payment process can be improved.

FIG. 6 depicts another exemplary information transmission apparatus consistent with various disclosed embodiments. As depicted in FIG. 6, the exemplary information transmission apparatus 1000 can include: at least one processor 1001 (e.g. a CPU), at least one network interface 1004, a user interface 1003, a storage device 1005, and at least one communication bus 1002. The communication bus 1002 is configured to implement communication connections between components. The user interface 1003 may include a display, and/or a keyboard. Optionally, the user interface 1003 may also include a standard wired interface, and a wireless interface. Optionally, the network interface 1004 may include a standard wired interface, and a wireless interface (e.g. a WI-FI interface). The storage device 1005 may include a high speed RAM memory, or a non-volatile memory, e.g. at least one disk storage device. Optionally, the storage device 1005 may include at least one storage device that is located far away from the above processor 1001. As shown in FIG. 6, as a computer storage medium, the storage device 1005 may include an operating system, a network communication module, a user interface module, and/or information transmission application programs.

In the information transmission apparatus 1000 depicted in FIG. 6, the network interface 1004 can be connected to the information transmission apparatus 1000 with the payment server to process data. The user interface 1003 can be configured to provide interface for user inputs to obtain data of user inputs. The processor 1001 can be used to call the information transmission application programs stored in storage device 1005, and to execute operations as follows.

The information transmission apparatus 1 generates an RF signal including payment information corresponding to a payment amount to be paid. The information transmission apparatus 1 outputs the RF signal to the payment terminal for the payment terminal to receive the RF signal and to parse the RF signal to obtain the payment information, and for the payment terminal to send a payment request to a bank server according to the payment information such that the bank server processes the payment request; and the information transmission apparatus 1 receives a process result after the payment request is processed, and sent from the bank server.

As such, the receiving terminal generates RF signal including the payment information corresponding to a payment amount to be paid. The payment terminal obtains the payment information by receiving the RF signal transmitted from the receiving terminal. Since the payment information is obtained through RF signal, compared with obtaining the payment information through internet in current technology, the present disclosure improves the security of the payment process.

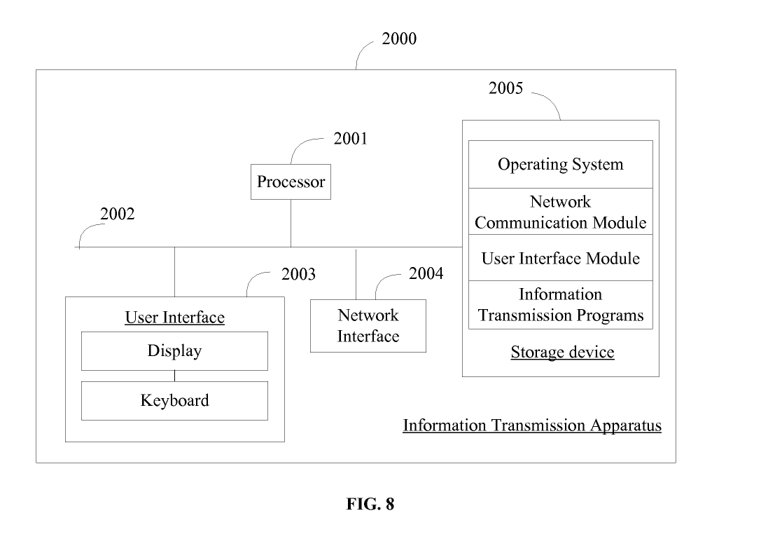

FIGS. 7-8 depict exemplary information transmission apparatuses consistent with various disclosed embodiments. It should be noted that apparatuses shown in FIGS. 7-8 can be, e.g., a payment terminal, used to implement the disclosed information transmission methods, e.g., as depicted in FIG. 2. For illustration purposes, only certain portions are disclosed for the apparatuses, although the disclosed apparatuses can be used to implement all possible steps of the information transmission methods (e.g., referring to FIGS. 1-4).

As depicted in FIG. 7, the exemplary information transmission apparatus includes a signal receiving unit 21, a sending unit 22, and/or a result receiving unit 23.

The signal receiving unit 21 is configured to receive an RF signal including payment information outputted from a receiving terminal. The RF signal includes a wireless NFC signal, a RFID signal, a bluetooth signal, and/or an infrared signal. The signal receiving unit 21 is also configured to parse the RF signal to obtain the payment information. Specifically, the receiving terminal generates and outputs an RF signal including the payment information through an application program. The signal receiving unit 21 receives the RF signal.

The payment information can include the payment amount to be paid. Or the payment information can include the payment amount to be paid and the receiving account number information. When the payment information does not include the receiving account number, the signal receiving unit 21 can first obtain the information of the application program that displays the above RF signal, and then find the receiving account number through the application program. For example, the information transmission apparatus 2 can pre-obtain a corresponding relationship between information of the application program and the receiving account number. The information transmission apparatus 2 can then obtain the receiving account number according to the corresponding relationship. In some cases, the information transmission apparatus 2 does not need to obtain the receiving account number, e.g. the receiving account number can be found by the terminal ID of the receiving terminal when the payment request is processed by the bank server.

The sending unit 22 is configured to send a payment request to a banker server according to the payment information. The payment request includes a payment account number and verification information of the payment account number for the bank server to process the payment request.

Specifically, when the signal receiving unit 21 receives the payment information, the information transmission apparatus 2 obtains the payment account number and the verification information of the payment account number. The sending unit 22 then sends a payment request including the payment account number and the verification information of the payment account number according to the payment information to a bank server. For example, the sending unit 22 sends the payment request including above payment information, the payment account number and the verification information of the payment account number to the bank server.

Optionally, the above payment account number and the verification information of the payment account number can be the payment account number pre-stored at the information transmission apparatus 2 and the verification information of the payment account number pre-stored at the payment terminal. Or the payment account number can be the inputted payment account number and the inputted verification information of the payment account number. Or the payment account number can be the payment account number pre-stored at the payment terminal, and the inputted verification information of the payment account number. The verification information of the above payment account number can be the verification information needed by the bank server when the payment account number is used during transfer. The verification information can include, but are not limited to, password, expiration date, and/or card ID. Optionally, when the sending unit 22 sends the payment request including the payment account number and the verification information of the payment account number to the bank server, the payment request including the payment account number and the verification information of the payment account number can be sent via a wired and/or the wireless network to the bank server.

Optionally, the sending unit 22 can send the payment request including the payment account number and the verification information of the payment account number to the bank server through a transaction server. For example, the sending unit 22 can send the payment request to the transaction server according to the payment information; and the transaction server can send the payment request to the bank server.

The transaction server can be a server providing a specific application software program running on the information transmission apparatus 2. For example, when the signal receiving unit 21 receives above RF signal through certain communication software program and the above payment account number corresponds to the communication account number of the communication software program, the information transmission apparatus 2 can obtain the payment account number and the verification information of the payment account number through the communication software program, and then the sending unit 22 can send the payment request including the payment account number and the verification information of the payment account number to the transaction server according to the payment information. The transaction server can send the payment request to the bank server.

In one embodiment, the payment request is forwarded from the transaction server to the bank server. Since the servers are harder to be attacked compared with the terminals, security of the payment process can be improved.

Further, when the bank server receives the payment request, the bank server processes the payment request. The result receiving unit is configured to receive a process result after the payment request is processed and sent from the bank server.

Specifically, the process result can include a successful payment or a failed payment. When the payment amount of the payment account number is transferred to the receiving account number, the payment is successful, otherwise the payment is unsuccessful. Optionally, once the result receiving unit 23 receives the process result after the payment request is processed, the information transmission apparatus 2 may output the process result.

As such, the receiving terminal generates the RF signal including the payment information corresponding to a payment amount to be paid. The payment terminal receives the RF signal from the receiving terminal and parses the RF signal to obtain the payment information. The payment terminal sends the payment request including the payment account number and the verification information of the payment account number to the bank server according to the payment information. Since the payment information is obtained through RF signal, compared with obtaining the payment information through internet in current technology, the security of the payment process can be improved, and the smartness of the information transmission system can be improved.

FIG. 8 depicts another exemplary information transmission apparatus consistent with various disclosed embodiments. As depicted in FIG. 8, the exemplary information transmission apparatus 2000 can include: at least one processor 2001 (e.g. a CPU), at least one network interface 2004, a user interface 2003, a storage device 2005, and at least one communication bus 2002. The communication bus 2002 is configured to implement communication connections between components.

The user interface 2003 may include a display and/or a keyboard. Optionally, the user interface 2003 may also include a standard wired interface, and a wireless interface. Optionally, the network interface 2004 may include a standard wired interface, and a wireless interface (e.g. a WI-FI interface). The storage device 2005 may include a high speed RAM memory, or a non-volatile memory, e.g. at least one disk storage device. Optionally, the storage device 2005 may include at least one storage device that is located far away from the above processor 2001. As shown in FIG. 8, as a computer storage medium, the storage device 2005 may include an operating system, a network communication module, a user interface module, and/or information transmission application programs.

In the information transmission apparatus 2000 depicted in FIG. 8, the network interface 2004 can be connected the information transmission apparatus 2000 with the payment server to process data; the user interface 2003 can be configured to provide interface for user inputs to obtain data of user inputs; the processor 2001 can be used to call the information transmission application programs stored in the storage device 2005, and to execute operations as follows.

The information transmission apparatus 2 receives an RF signal including payment information outputted from a receiving terminal and parses the RF signal to obtain the payment information. The RF signal includes a wireless NFC signal, a RFID signal, a bluetooth signal, and/or an infrared signal. The information transmission apparatus 2 sends a payment request to a banker server according to the payment information. The payment request includes a payment account number and verification information of the payment account number for the bank server to process the payment request. The information transmissions apparatus 2 receives a process result after the payment request is processed, and sent from the bank server.

As such, the receiving terminal generates the RF signal including the payment information corresponding to a payment amount to be paid. The payment terminal receives the RF signal from the receiving terminal and parses the RF signal to obtain the payment information. The payment terminal sends the payment request including the payment account number and the verification information of the payment account number to the bank server according to the payment information. Since the payment information is obtained through RF signal, compared with obtaining the payment information through internet in current technology, the security of the payment process can be improved, and the smartness of the information transmission system can be improved.

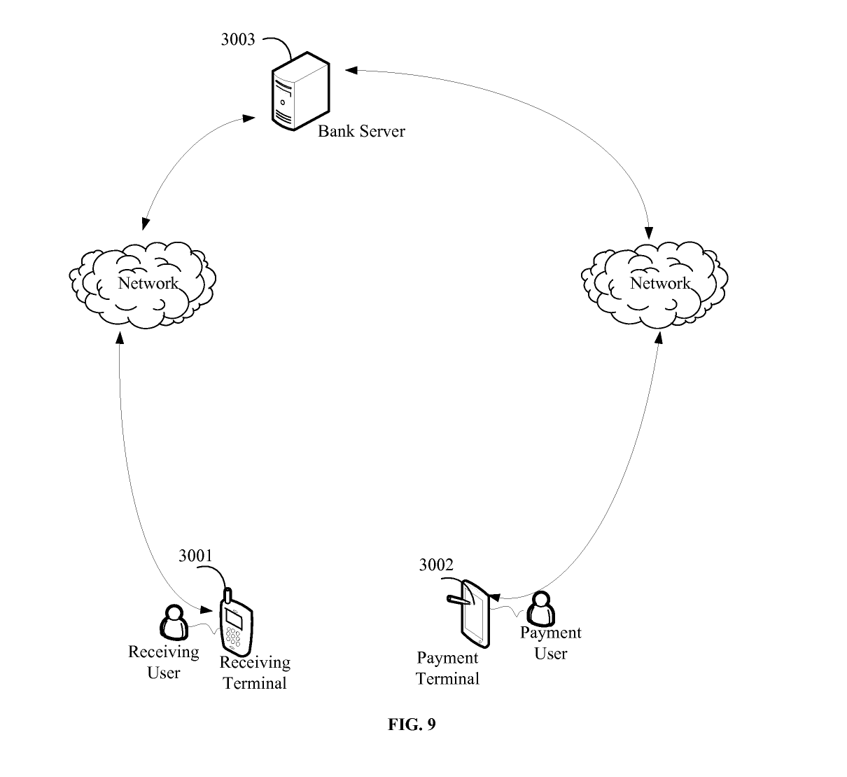

FIG. 9 depicts an exemplary information transmission system consistent with various disclosed embodiments. As depicted in FIG. 9, the exemplary information transmission system includes a receiving terminal 3001, a payment terminal 3002, and/or a bank server 3003.

The receiving terminal 3001 is configured to generate an RF signal including payment information corresponding to a payment amount to be paid.

The payment terminal 3002 is configured to receive the RF signal transmitted from the receiving terminal, and parse the RF signal to obtain the payment information. The RF signal includes a wireless near field communication (NFC) signal, a radio frequency identification (RFID) signal, a bluetooth signal, and/or an infrared signal. The payment terminal is also configured to send a payment request to a bank server, according to the payment information. The payment request includes a payment account number and verification information of the payment account number.

The bank server 3003 is configured to process the payment request, and send a process result after processing to the payment terminal and the receiving terminal.

In another embodiment, the receiving terminal 3001 is further configured to output the process result. The payment terminal 3002 is further configured to output the process result. The process result includes a successful payment or a failed payment.

In another embodiment, the payment terminal 3002 is further configured to obtain a pre-stored payment account number and pre-stored verification information of the payment account number. Or the payment terminal 3002 is further configured to obtain a pre-stored payment account number, and receive inputted verification information of the payment account number. Or the payment terminal 3002 is further configured to receive an inputted payment account number and inputted verification information of the payment account number.

In another embodiment, the payment terminal 3002 is further configured to output a prompt message to prompt for ID verification, when the payment amount included in the payment information exceeds a pre-set amount value. The payment terminal 3002 is further configured to scan a body part for the ID verification, to obtain ID verification information. The payment terminal 3002 is further configured to verify the ID verification information. The payment terminal 3002 is further configured to send a payment request to a bank server according to the payment information after the ID verification information is successfully verified.

In another embodiment, the payment terminal 3002 is further configured to output a prompt message to prompt for ID verification, when the payment amount included in the payment information exceeds a pre-set amount value. The payment terminal 3002 is further configured to scan a body part for the ID verification, to obtain ID verification information. The payment terminal 3002 is further configured to send the payment request and the ID verification information to the bank server according to the payment information. The bank server 3003 is further configured to verify the ID verification information, and process the payment request after the ID verification information is successfully verified.

In another embodiment, the payment terminal 3002 is further configured to scan a fingerprint to obtain fingerprint information. Or the payment terminal 3002 is further configured to scan a pupil to obtain pupil information. Or the payment terminal 3002 is further configured to scan a face to obtain facial information.

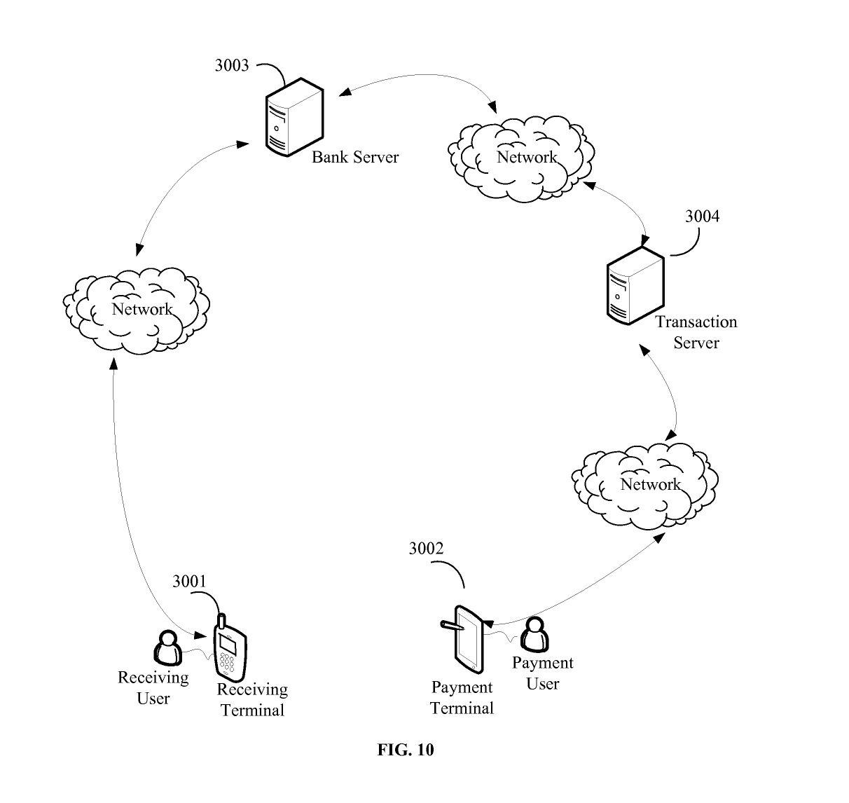

Optionally, as depicted in FIG. 10, the information transmission system further includes a transaction server 3004. The payment terminal 3002 is further configured to send the payment request to the transaction server 3004 according to the payment information. The transaction server 300 is configured to send the payment request to the bank server 3003.

As such, the receiving terminal generates the RF signal including the payment information corresponding to a payment amount to be paid. The payment terminal receives the RF signal from the receiving terminal and parses the RF signal to obtain the payment information. The payment terminal sends the payment request including the payment account number and the verification information of the payment account number to the bank server according to the payment information. Since the payment information is obtained through RF signal, compared with obtaining the payment information through internet in current technology, the security of the payment process can be improved, and the smartness of the information transmission system can be improved.

One of ordinary skill in the art would appreciate that suitable software and/or hardware (e.g., a universal hardware platform) may be included and used in the disclosed methods, apparatus, and/or systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

It should be noted that, in the present disclosure each embodiment is progressively described, i.e., each embodiment is described and focused on difference between embodiments. Similar and/or the same portions between various embodiments can be referred to with each other. In addition, exemplary apparatus and/or systems are described with respect to corresponding methods.

The disclosed methods, apparatus, and/or systems can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The methods, apparatus, and/or systems can be implemented in a software manner. Of course, the methods, apparatus, and/or systems can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods, apparatus, and/or systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the disclosed methods, apparatus, and systems for information transmission, the receiving terminal generates the RF signal including the payment information corresponding to a payment amount to be paid. The payment terminal receives the RF signal from the receiving terminal and parses the RF signal to obtain the payment information. The payment terminal sends the payment request including the payment account number and the verification information of the payment account number to the bank server according to the payment information. Since the payment information is transmitted through RF signal, compared with obtaining the payment information through internet in current technology, the security of the payment process can be improved and the smartness of the information transmission systems can be improved.

What is claimed is:

1. A method for information transmission, comprising:
receiving, by a payment terminal, a radio frequency (RF) signal generated and transmitted from a receiving terminal, the RF signal comprising payment information corresponding to a payment amount to be paid;
parsing, by the payment terminal, the RF signal to obtain the payment information; and
sending, by the payment terminal, a payment request to a bank server according to the payment information for the bank server to process the payment request and to send a process result after processing to the payment terminal and the receiving terminal, wherein the payment request includes a payment account number and verification information of the payment account number.

2. The method according to claim 1, wherein the RF signal comprises a wireless NFC signal, a RFID signal, a bluetooth signal, an infrared signal, and a combination thereof.

3. The method according to claim 1, wherein, after the payment request is processed and the process result is sent, the method further comprises:
outputting the process result by the receiving terminal; and
outputting the process result by the payment terminal, wherein the process result comprises information of a successful payment or a failed payment.

4. The method according to claim 1, wherein, before the sending of the payment request to the bank server according to the payment information, the method further comprises:
obtaining, by the payment terminal, a pre-stored payment account number and pre-stored verification information of the payment account number; or
obtaining, by the payment terminal, a pre-stored payment account number, and receiving inputted verification information of the payment account number; or
receiving, by the payment terminal, an inputted payment account number and inputted verification information of the payment account number.

5. The method according to claim 1, wherein, after the receiving and parsing of the RF signal to obtain the payment information, and before the sending of the payment request to the bank server, the method further comprises:
outputting, by the payment terminal, a prompt message to prompt for an ID verification, when the payment amount included in the payment information exceeds a pre-set amount value;
scanning, by the payment terminal, a body part for the ID verification, to obtain ID verification information; and
verifying, by the payment terminal, the ID verification information, and
wherein the sending of the payment request to the bank server by the payment terminal according to the payment information comprises:
after the ID verification information is successfully verified, sending, by the payment terminal, the payment request to the bank server according to the payment information.

6. The method according to claim 1, wherein, after the receiving and parsing of the RF signal by the payment terminal, and before the sending of the payment request to the bank server by the payment terminal, the method further comprises:
outputting, by the payment terminal, a prompt message to prompt for an ID verification, when the payment amount included in the payment information exceeds a pre-set amount value; and
scanning, by the payment terminal, a body part for the ID verification, to obtain ID verification information;
wherein the sending of the payment request to the bank server by the payment terminal comprises:
sending, by the payment terminal, the payment request and the ID verification information to the bank server according to the payment information; and
wherein the processing of the payment request by the bank server comprises:
verifying, by the bank server, the ID verification information, and processing, by the bank server, the payment request after the ID verification information is successfully verified.

7. The method according to claim 5, wherein the scanning of the body part for the ID verification by the payment terminal to obtain the ID verification information comprises:
scanning, by the payment terminal, a fingerprint to obtain fingerprint information; or
scanning, by the payment terminal, a pupil to obtain pupil information; or
scanning, by the payment terminal, a face to obtain facial information.

8. The method according to claim 1, wherein the sending of the payment request to the bank server by the payment terminal according to the payment information comprises:
sending, by the payment terminal, the payment request to a transaction server according to the payment information for the transaction server to send the payment request to the bank server.

9. An information transmission system comprising:
a payment terminal configured: to receive a radio frequency (RF) signal generated and transmitted from a receiving terminal, the RF signal comprising payment information corresponding to a payment amount to be paid; to parse the RF signal to obtain the payment information; and to send a payment request to a bank server according to the payment information, such that the bank server processes the payment request and sends a process result after processing to the payment terminal and the receiving terminal,
wherein the payment request comprises a payment account number and verification information of the payment account number.

10. The system according to claim 9, wherein the RF signal comprises a wireless near field communication (NFC) signal, a radio frequency identification (RFID) signal, a bluetooth signal, an infrared signal, and a combination thereof.

11. The system according to claim 9, further comprising the receiving terminal, wherein:
the receiving terminal is further configured to output the process result; and
the payment terminal is further configured to output the process result, wherein the process result comprises information of a successful payment or a failed payment.

12. The system according to claim 9, wherein:
the payment terminal is further configured to obtain a pre-stored payment account number and pre-stored verification information of the payment account number; or
the payment terminal is further configured to obtain a pre-stored payment account number, and receive inputted verification information of the payment account number; or
the payment terminal is further configured to receive an inputted payment account number and an inputted verification information of the payment account number.

13. The system according to claim 9, wherein:
the payment terminal is further configured to output a prompt message to prompt for an ID verification, when the payment amount included in the payment information exceeds a pre-set amount value;
the payment terminal is further configured to scan a body part for the ID verification, to obtain ID verification information;
the payment terminal is further configured to verify the ID verification information; and
the payment terminal is further configured to send the payment request to the bank server according to the payment information, after the ID verification information is successfully verified.

14. The system according to claim 9, wherein:
the payment terminal is further configured to output a prompt message to prompt for ID verification, when the payment amount included in the payment information exceeds a pre-set amount value;
the payment terminal is further configured to scan a body part for the ID verification, to obtain ID verification information;
the payment terminal is further configured to send the payment request and the ID verification information to the bank server according to the payment information; and
the bank server is further configured to verify the ID verification information, and process the payment request after the ID verification information is successfully verified.

15. The system according to claim 13, wherein:
the payment terminal is further configured to scan a fingerprint to obtain fingerprint information; or
the payment terminal is further configured to scan a pupil to obtain pupil information; or
the payment terminal is further configured to scan a face to obtain facial information.

16. The system according to claim 9, further comprising a transaction server, wherein:
the payment terminal is further configured to send the payment request to the transaction server according to the payment information for the transaction server to send the payment request to the bank server.
